(19) United States
(12) Patent Application Publication
(10) Pub. No.: US 2024/0313494 A1
(43) Pub. Date: Sep. 19, 2024

(54) TERMINAL REEL UNIT AND ELECTRIC WIRE PROCESSING APPARATUS

(71) Applicant: Yazaki Corporation, Tokyo (JP)

(72) Inventors: Takuya NAKADA, Makinohara-shi (JP); Yuta SUGANUMA, Makinohara-shi (JP); Akihiro MIZUNO, Makinohara-shi (JP)

(73) Assignee: Yazaki Corporation, Tokyo (JP)

(21) Appl. No.: 18/672,584

(22) Filed: May 23, 2024

Related U.S. Application Data
(63) Continuation of application No. PCT/JP2022/045284, filed on Dec. 8, 2022.

(30) Foreign Application Priority Data
Dec. 27, 2021 (JP) 2021-212940

(51) Int. Cl. H01R 43/052

(52) U.S. Cl. CPC H01R 43/052

(57) ABSTRACT

A terminal reel unit includes: a reel holding portion configured to detachably hold a terminal reel; a crimping portion disposed at a position in front of the terminal reel in a pull-out direction of a terminal chain body from the terminal reel when the terminal reel is held by the reel holding portion, and configured to crimp a terminal of the terminal chain body pulled out from the terminal reel to an electric wire supplied for the terminal and separate the terminal from the terminal chain body; and a unit frame which is a frame set detachably with respect to a device for supplying the terminal to the crimping portion, and to which the reel holding portion and the crimping portion are attached.

The present invention relates to a terminal reel unit and an electric wire processing apparatus for cutting a segment electric wire and manufacturing a terminal-equipped electric wire. The present application is a continuation application of International Application No. PCT/JP2022/045284, filed on Dec. 8, 2022, whose priority is claimed on Japanese Patent Application No. 2021-212940, filed on Dec. 27, 2021. All of the contents of the International Application and the Japanese Patent Application are incorporated herein with reference.

### TECHNICAL FIELD

### Background Art

In the related art, as an example of an electric wire processing apparatus for cutting out a segment electric wire and manufacturing a terminal-equipped electric wire, an electric wire processing apparatus in which a plurality of terminal reel units are arranged and accommodated is known (for example, see Patent Literature 1). The terminal reel unit described in Patent Literature 1 holds a terminal reel around which a strip-shaped terminal chain body in which a plurality of terminals are connected with each other is wound. In the electric wire processing apparatus, one of the plurality of accommodated terminal reel units is selected and moved to a predetermined supply position. Thereafter, the terminal chain body is pulled out from the terminal reel in the one terminal reel unit at the supply position, and terminal crimping is performed by a crimping machine positioned at the supply position.

### CITATION LIST

### Patent Literature

Patent Literature 1: Japanese Patent No. 6383266

### SUMMARY OF INVENTION

### Technical Problem

Here, in the electric wire processing apparatus described above, it often takes time to perform processes in a plurality of stages, such as movement of the terminal reel and setting of the terminal reel into the crimping machine before the terminal crimping. That is, in the electric wire processing apparatus described above, there is room for improvement in terms of work efficiency of the processes in preceding stages of the terminal crimping.

Therefore, the present invention focus on the above-mentioned problems and an object thereof is to provide a terminal reel unit and an electric wire processing apparatus in which processes in preceding stages of terminal crimping can be performed efficiently.

### Solution to Problem

In order to solve the above problem, a terminal reel unit includes a reel holding portion configured to detachably hold a terminal reel around which a strip-shaped terminal chain body in which a plurality of terminals are connected to each other is wound, a crimping portion which is disposed at a position in a front side with respect to the terminal reel in a pull-out direction of the terminal chain body from the terminal reel when the terminal reel is held by the reel holding portion, the crimping portion forming at least a part of a crimping machine configured to crimp the terminal of the terminal chain body having been pulled out from the terminal reel, to an electric wire and to separate the terminal from the terminal chain body and a unit frame being a frame set detachably with respect to a device configured to supply the terminal to the crimping machine, and to which the reel holding portion and the crimping portion are attached.

### Advantageous Effects of Invention

According to the above-described terminal reel unit and the electric wire processing apparatus including the terminal reel unit, the processes in preceding stages of the terminal crimping can be performed efficiently.

### BRIEF DESCRIPTION OF DRAWINGS

FIG. 1 is an external view showing an electric wire processing apparatus according to an embodiment.

FIG. 2 is a schematic diagram showing a main part of the electric wire processing apparatus shown in FIG. 1 for performing cutting of a segment electric wire and terminal crimping.

FIG. 3 is a schematic diagram showing an example of a terminal-equipped electric wire manufactured in the electric wire processing apparatus shown in FIGS. 1 and 2.

FIG. 4 is an enlarged external perspective view showing a vicinity of a B-side terminal supply unit in the electric wire processing apparatus shown in FIGS. 1 and 2.

FIG. 5 is an external perspective view showing a terminal reel unit shown in FIG. 4 in a state where a terminal reel is held.

FIG. 6 is an external perspective view showing the terminal reel unit shown in FIG. 5 in a state where the terminal reel is removed.

FIG. 7 is a schematic view showing a state where terminal crimping is performed in a crimping portion shown in FIGS. 5 and 6.

FIG. 8 is a view showing a plurality of terminal reel units and a supply mechanism in a state before one of the terminal reel units is moved.

FIG. 9 is a view showing the plurality of terminal reel units and the supply mechanism in a state where the one terminal reel unit is moved.

FIG. 10 is a view showing a state where a reel holding portion of a terminal reel unit that is a replacement target is pivoted during replacement of the terminal reel or the like.

### DESCRIPTION OF EMBODIMENTS

Hereinafter, a terminal reel unit and an electric wire processing apparatus according to an embodiment will be described.

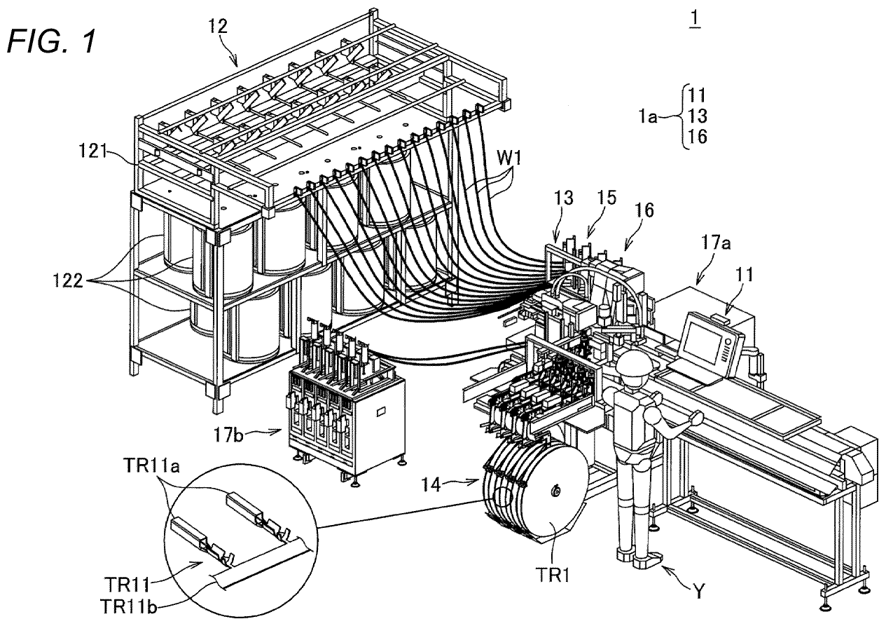

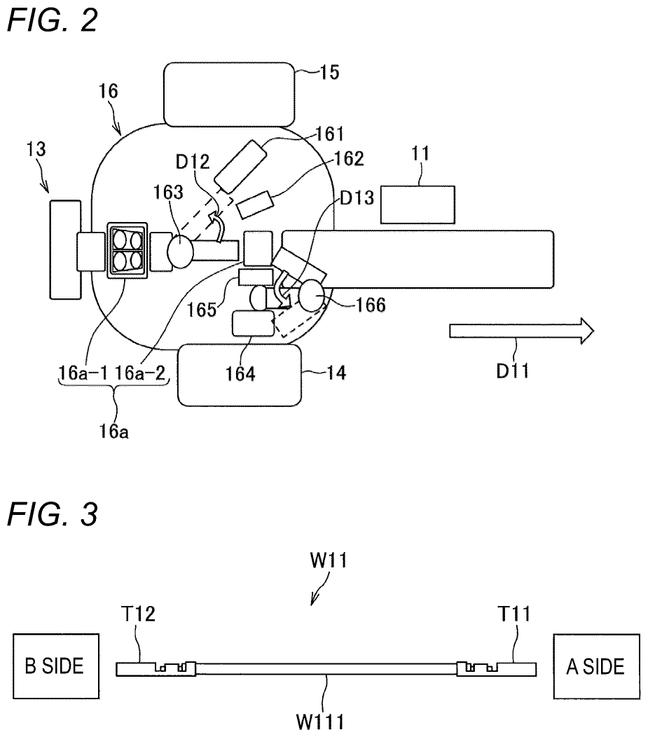

FIG. 1 is an external view showing the electric wire processing apparatus according to the embodiment, and FIG. 2 is a schematic diagram showing a main part of the electric wire processing apparatus shown in FIG. 1 for performing cutting of a segment electric wire and terminal crimping. FIG. 3 is a schematic diagram showing an example of a terminal-equipped electric wire manufactured in the electric wire processing apparatus shown in FIGS. 1 and 2.

An electric wire processing apparatus 1 shown in FIGS. 1 and 2 is an apparatus for manufacturing a terminal-equipped electric wire W11 whose example is shown in FIG. 3, for example. FIG. 3 shows an example of the terminal-equipped electric wire W11 in which terminals are crimped to both ends of a segment electric wire W111.

When the terminal-equipped electric wire W11 shown in FIG. 3 is manufactured by the electric wire processing apparatus 1, as to be described later, the supplied electric wire W1 is fed out in a feed-out direction D11 indicated by an arrow in FIG. 2, and the segment electric wire W111 is cut out. Here, a front side and a rear side in the feed-out direction D11 are referred to as an A side and a B side, respectively, a terminal to be crimped to the A side of the segment electric wire W111 is referred to as an A-side terminal T11, and a terminal to be crimped to the B side is referred to as a B-side terminal T12. The terminal-equipped electric wire is not limited to the form of FIG. 3, and the terminal-equipped electric wire may be one in which the terminal is crimped only to one end of the segment electric wire as long as the terminal is crimped to at least one end of the segment electric wire. Further, in the electric wire processing apparatus 1, it is also possible to perform only cutting of the segment electric wire W111 including stripping of the end portion without performing the terminal crimping. Hereinafter, the electric wire processing apparatus 1 shown in FIGS. 1 and 2 will be described as a device for manufacturing the terminal-equipped electric wire W11 in which the terminals T11 and T12 are crimped to both ends, based on the example of FIG. 3.

The electric wire processing apparatus 1 includes an information acquisition unit 11, an electric wire storage rack 12, an electric wire supply device 13, a B-side terminal supply unit 14, an A-side terminal supply unit 15, a body mechanism 16, an A-side rubber plug supply unit 17a, and a B-side rubber plug supply unit 17b.

In order to manufacture the terminal-equipped electric wire W11, the information acquisition unit 11 acquires manufacturing information including an electric wire type of the segment electric wire W111 and a terminal type of the terminal. Specifically, the information acquisition unit 11 receives an input from an operator Y and acquires, as the manufacturing information, part number data associated with the electric wire type and the terminal type.

In the electric wire storage rack 12, a plurality of electric wire reels 122 of different electric wire types are accommodated in a rack body 121. The electric wires wound around the plurality of electric wire reels 122 are coated electric wires having different thicknesses, colors, and the like. The electric wires W1 pulled out from a predetermined number of electric wire reels 122 selected from the plurality of electric wire reels 122 are extended to the electric wire supply device 13 as candidates for cutting out of the segment electric wires W111.

The electric wire supply device 13 is a device in which a target electric wire as a supply target is selected from among a plurality of types of electric wires W1 from the electric wire storage rack 12, and the target electric wire is supplied to a supply position for cutting of the segment electric wire W111 or terminal crimping. The target electric wire is selected based on the part number data acquired by the information acquisition unit 11.

Each of the B-side terminal supply unit 14 and the A-side terminal supply unit 15 holds a plurality of types of terminal reels TR1 different in terminal type, and around the terminal reel TR1, a terminal chain body TR11 in which a plurality of terminals TR11a are connected via a band-shaped carrier TR11b is wound. The B-side terminal supply unit 14 holds a plurality of types of terminal reels TR1 as candidates for the B-side terminal T12, and the A-side terminal supply unit 15 holds a plurality of types of terminal reels TR1 as candidates for the A-side terminal T11. Then, the B-side terminal supply unit 14 and the A-side terminal supply unit 15 respectively designate target terminal reels from among the plurality of types of terminal reels TR1 for the B-side and the A-side, and supply the target terminal reels. The B-side terminal supply unit 14 and the A-side terminal supply unit 15 have substantially the same structure, and will be described in detail later by taking the B-side terminal supply unit 14 as a typical example.

The body mechanism 16 cuts out the segment electric wire W111 from the target electric wire supplied from the electric wire supply device 13, and crimps terminals of the supplied target terminal reel to end portions on the B side and the A side of the segment electric wire W111 to manufacture the terminal-equipped electric wire W11. The body mechanism 16 includes a cutout part 16a that first cuts out the segment electric wire W111 by feeding out and cutting the target electric wire in the feed-out direction D11. The cutout part 16a includes a feed-out mechanism 16a-1 that performs feeding out and a cutting mechanism 16a-2 that performs cutting. The cutting mechanism 16a-2 is a mechanism capable of stripping coating on the end portion of the cut electric wire.

The body mechanism 16 includes an A-side crimping machine 161, an A-side rubber plug inserting machine 162, and an A-side electric wire moving arm 163 as mechanism parts for A-side terminal crimping. Here, the A-side terminal crimping refers to terminal crimping performed on a front end of the target electric wire in the feed-out direction D11. The A-side crimping machine 161 crimps the terminal of the target terminal reel supplied by the A-side terminal supply unit 15 as the A-side terminal T11 to the front end of the target electric wire in the feed-out direction D11. When an A-side rubber plug is supplied from the A-side rubber plug supply unit 17a as to be described later, the A-side rubber plug inserting machine 162 inserts the A-side rubber plug to the front end of the target electric wire in the feed-out direction D11 prior to the terminal crimping in the A-side crimping machine 161. In this case, the terminal crimping in the A-side crimping machine 161 is performed from above the inserted rubber plug. The A-side electric wire moving arm 163 is an A-side arm mechanism that grips the target electric wire fed out by the cutout part 16a, moves the front end of the target electric wire in the feed-out direction D11 along a direction indicated by an arrow D12, and positions the target electric wire with respect to the A-side crimping machine 161 and the A-side rubber plug inserting machine 162.

Further, the body mechanism 16 includes a B-side crimping machine 164, a B-side rubber plug inserting machine 165, and a B-side electric wire moving arm 166 as mechanism parts for B-side terminal crimping. Here, the B-side terminal crimping refers to terminal crimping performed on a rear end in the feed-out direction D11 of the terminal-equipped segment electric wire that is cut out after receiving the terminal crimping in the A-side crimping machine 161. The B-side crimping machine 164 crimps the terminal of the target terminal reel supplied by the B-side terminal supply unit 14 as the B-side terminal T12 to the rear end of the terminal-equipped segment electric wire in the feed-out direction D11. When a B-side rubber plug is supplied from the B-side rubber plug supply unit 17a as to be described later, the B-side rubber plug inserting machine 165 inserts the B-side rubber plug to the rear end of the terminal-equipped segment electric wire in the feed-out direction D11 prior to the terminal crimping in the B-side crimping machine 164. In this case, the terminal crimping in the B-side crimping machine 164 is performed from above the inserted rubber plug. The B-side electric wire moving arm 166 is a B-side arm mechanism that grips the terminal-equipped segment electric wire cut out by the cutout part 16a, moves the rear end in the feed-out direction D11 along a direction indicated by an arrow D13, and positions the terminal-equipped segment electric wire with respect to the B-side crimping machine 164 and the B-side rubber plug inserting machine 165.

The A-side rubber plug supply unit 17a and the B-side rubber plug supply unit 17b are devices that each hold a plurality of types of rubber plugs and respectively supply the rubber plugs to the A-side rubber plug inserting machine 162 and the B-side rubber plug inserting machine 165. In the present embodiment, although not shown, the terminal-equipped electric wire W11 can be manufactured by any processing type of a rubber plug insertion type in which terminal crimping is performed from above a rubber plug and a rubber plug non-insertion type in which terminal crimping is directly performed on an end portion of a segment electric wire. Further, as a processing type, it is also possible to perform electric wire cutting in which only cut out of the segment electric wire W111 and stripping of the end portion are performed without performing any of the terminal crimping and the rubber plug insertion. In the manufacturing information, that is, the part number data, in addition to the electric wire type and the terminal type, any processing type of the rubber plug insertion type, the rubber plug non-insertion type, and the electric wire cutting, and the rubber plug type in the case of the rubber plug insertion type are associated. The A-side rubber plug supply unit 17a and the B-side rubber plug supply unit 17b respectively supply the rubber plugs of selected rubber plug types to the A-side rubber plug inserting machine 162 and the B-side rubber plug inserting machine 165 based on the part number data in the case of rubber plug insertion type.

In the electric wire processing apparatus 1 schematically described above, prior to the processing of the electric wire, the operator Y inputs the part number data to the information acquisition unit 11. Thereafter, when a start button is pressed, the electric wire supply based on the part number data is performed by the electric wire supply device 13, and the supply of respective target terminal reels on the A side and the B side and the supply of respective rubber plugs on the A side and the B side in the case of the rubber plug insertion type are performed. Then, in the body mechanism 16, the electric wire cutting and the manufacture of the terminal-equipped electric wire W11 are performed using the supplied target electric wire, the terminal of the target terminal reel, and the rubber plug. The segment electric wire W111 that is cut off and the manufactured terminal-equipped electric wire W11 are discharged to a predetermined accommodation place. In addition, the number of manufactured segment electric wires W111 and the number of manufactured terminal-equipped electric wires W11 are also associated with the part number data, and the electric wire cutting and the manufacture of the terminal-equipped electric wires W11 are repeatedly executed until the designated number of manufactured electric wires is reached.

Next, the B-side terminal supply unit 14 and the A-side terminal supply unit 15 having substantially the same structure will be described in detail with reference to other drawings by taking the B-side terminal supply unit 14 as a representative example.

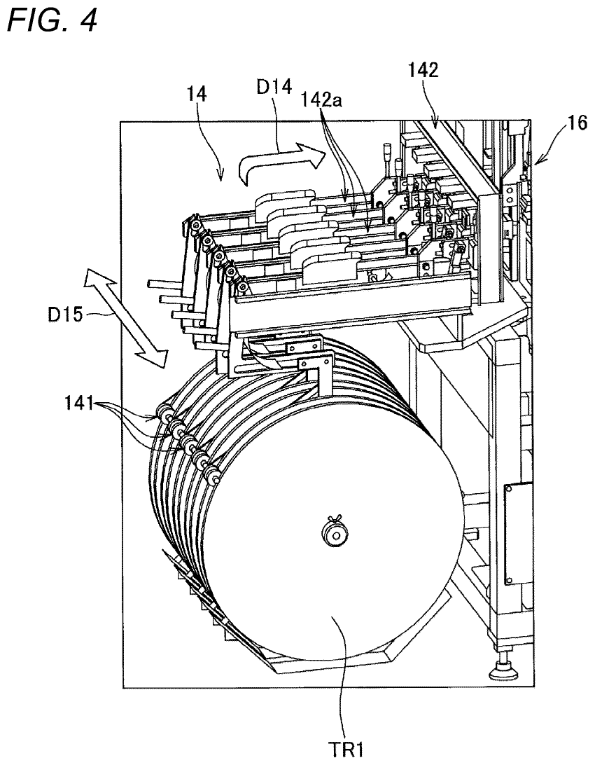

FIG. 4 is an enlarged external perspective view showing a vicinity of the B-side terminal supply unit in the electric wire processing apparatus shown in FIGS. 1 and 2.

The B-side terminal supply unit 14 includes a plurality of terminal reel units 141 and a supply mechanism 142, and the electric wire processing apparatus 1 includes the B-side terminal supply unit 14, the A-side terminal supply unit 15 having a structure equivalent to that of the B-side terminal supply unit 14, and an apparatus body 1a. As shown in FIG. 1, the apparatus body 1a is a functional unit including the information acquisition unit 11, the electric wire supply device 13, and the body mechanism 16. In the apparatus body 1a, the terminal chain body TR11 is pulled out from the target terminal reel held in one of the terminal reel units supplied by the supply mechanism 142 as to be described later, and the terminal TR11a is set in a crimping portion to be described later. Further, in the apparatus body 1a, the segment electric wire W111 is supplied to the terminal TR11a based on the electric wire supply from the electric wire supply device 13, and the terminals TR11a are crimped to both ends of the segment electric wire W111 to manufacture the terminal-equipped electric wire W11.

On the other hand, when the B-side terminal supply unit 14 and the A-side terminal supply unit 15 are described with the B-side terminal supply unit 14 as a representative example, each of the provided plurality of terminal reel units 141 is a member that detachably holds the terminal reels TR1. Further, in the supply mechanism 142, the plurality of terminal reel units 141 are detachably set in a state of holding the plurality of types of terminal reels TR1 having different terminal types on a one-to-one basis. The supply mechanism 142 is provided with a plurality of receiving slots 142a for receiving the plurality of terminal reel units 141 on a one-to-one basis. When the target terminal reel is selected, the supply mechanism 142 moves one terminal reel unit holding the target terminal reel among the plurality of terminal reel units 141 to a position where the terminal TR11a can be supplied to the crimping portion 141b.

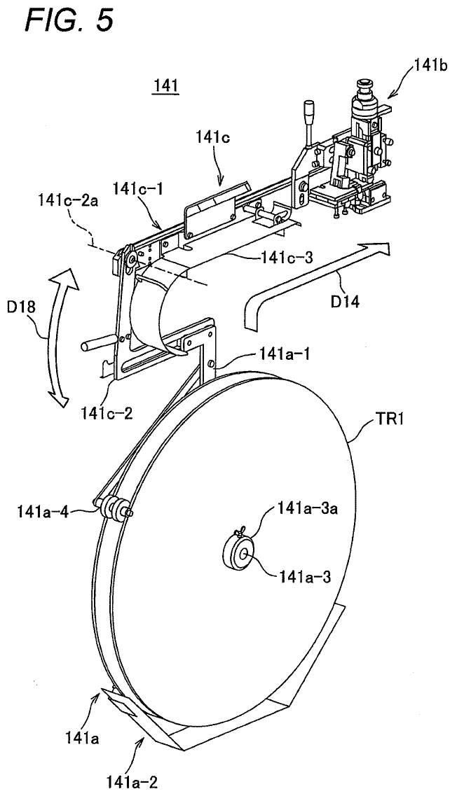

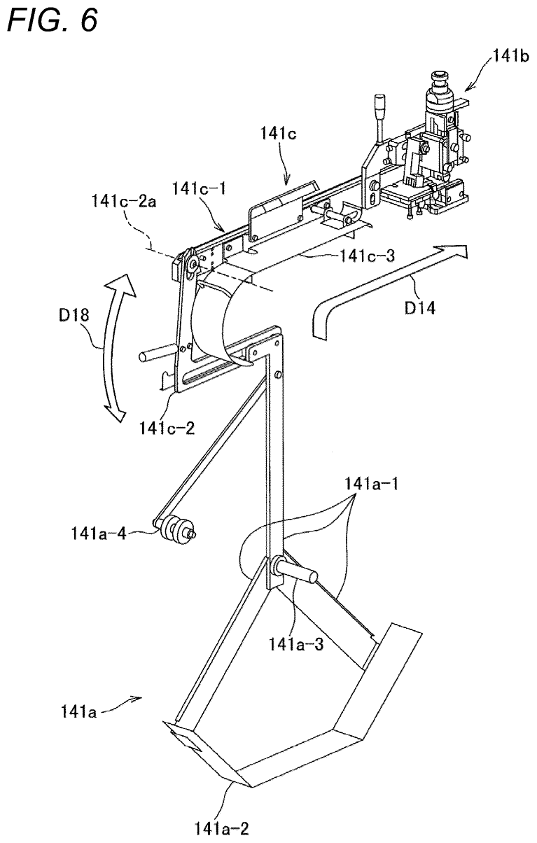

FIG. 5 is an external perspective view showing the terminal reel unit shown in FIG. 4 in a state in which the terminal reel is held, and FIG. 6 is an external perspective view showing the terminal reel unit shown in FIG. 5 in a state in which the terminal reel is removed.

The terminal reel unit 141 includes a reel holding portion 141a, a crimping portion 141b, and a unit frame 141c.

The reel holding portion 141a is a portion that detachably holds the terminal reel TR1, and includes three skeleton frames 141a-1, a reel cover 141a-2, a reel support shaft 141a-3, and an interlayer paper winding portion 141a-4. One of the three skeleton frames 141a-1 extends upward in the electric wire processing apparatus 1, and the other two skeleton frames 141a-1 are combined in a Y shape extending downward. The reel cover 141a-2 is a cover member that is held at end portions of the two lower skeleton frames 141a-1 and is formed by bending a strip into a shape covering a lower side of the terminal reel TR1. The reel support shaft 141a-3 is a shaft member that protrudes from a Y-shaped coupling center formed by the three skeleton frames 141a-1, and passes through a center of the terminal reel TR1 to rotatably support the terminal reel TR1. A holding member 141a-3a shown in FIG. 5 is attached to a tip end of the reel support shaft 141a-3 passing through the center of the terminal reel TR1, and the terminal reel TR1 is rotatably held. In addition, the terminal reel TR1 can be detached by detaching the holding member 141a-3a from the tip end of the reel support shaft 141a-3. Here, in the terminal reel TR1, an interlayer paper (not shown) is sandwiched between layers of the terminal chain body TR11 wound into a spiral layer. The interlayer paper winding portion 141a-4 is a rod-shape member whose one end is supported by the upper skeleton frame 141a-1, and is a member that winds and removes the interlayer paper when the terminal reel TR1 is pulled out by a rotating roller provided at an opposite tip end portion of the one end.

The crimping portion 141b is a member that is disposed at a position in front of the terminal reel TR1 in a pull-out direction D14 of the terminal chain body TR11 from the terminal reel TR1 when the terminal reel TR1 is held by the reel holding portion 141a, and performs terminal crimping.

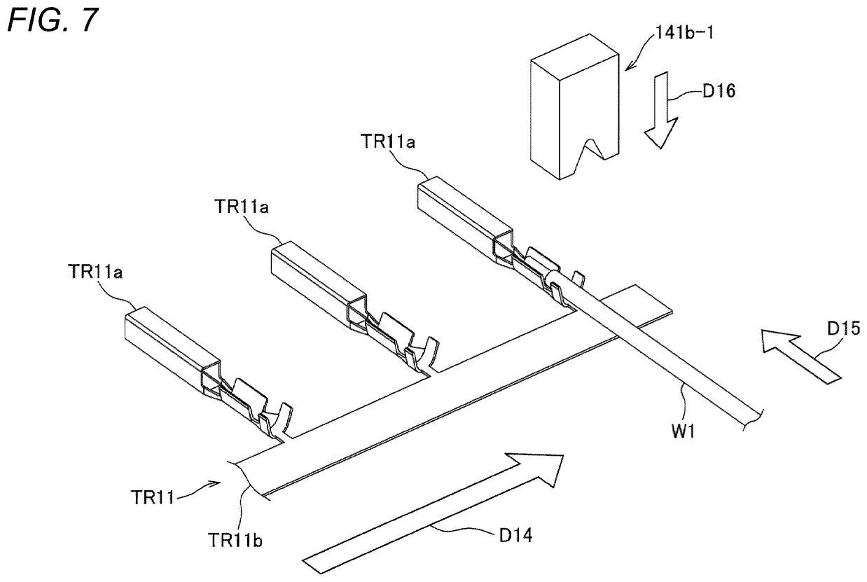

FIG. 7 is a schematic view showing a state where terminal crimping is performed in the crimping portion shown in FIGS. 5 and 6.

In the crimping portion 141b, the terminals TR11a of the terminal chain body TR11 pulled out from the terminal reel TR1 are sequentially set in the pull-out direction D14. Then, when the electric wire W1 is supplied to each terminal TRlla in an electric wire supply direction D15, a crimper 141b-1 provided on the crimping portion 141b is lowered in a crimping direction D16 to apply a pressure on a crimping position, and thus the terminal TRIla is crimped to the electric wire W1. During the crimping, the terminal TRIla is separated from the carrier TR11b of the terminal chain body TR11.

In the present embodiment, when the supply mechanism 142 moves the one terminal reel unit, the crimping portion 141b on the one terminal reel unit is assembled into the body mechanism 16. The crimping portion 141b thus assembled is a mechanism part in charge of terminal crimping in the A-side crimping machine 161 on the A-side, and is a mechanism part in charge of terminal crimping in the B-side crimping machine 164 on the B-side.

Next, the unit frame 141c shown in FIGS. 5 and 6 will be described. The unit frame 141c is a frame that is set detachably with respect to the supply mechanism 142 in the electric wire processing apparatus 1 that supplies the terminals TR11a to the A-side crimping machine 161 and the B-side crimping machine 164, which are assembling destinations of the crimping portion 141b. The reel holding portion 141a and the crimping portion 141b are attached to the unit frame 141c. As described above, the supply mechanism 142 is provided with the plurality of receiving slots 142a, and the unit frame 141c can be inserted into and removed from the receiving slot 142a. The unit frame 141c includes a frame body 141c-1, a pivot arm 141c-2, and a guide path 141c-3.

The frame body 141c-1 is a strip member that is formed in an elongated shape and attached with the crimping portion 141b at one end thereof. The pivot arm 141c-2 is an arm member that is attached to the other end of the frame body 141c-1 on an opposite side with respect to the crimping portion 141b, and supports the reel holding portion 141a pivotally in a pivoting direction D18 around a rotation shaft 141c-2a intersecting the other end of the frame body 141c-1. In the present embodiment, the pivot arm 141c-2 is an L-shaped member, and a tip end of the L-shaped vertical bar portion is supported by an end portion of the frame body 141c-1 pivotally around the rotation shaft 141c-2a. The pivotal support is performed such that the L-shaped horizontal bar portion faces the pull-out direction D14 of the terminal chain body TR11, and a tip end of the upper skeleton frame 141a-1 of the reel holding portion 141a is fixed to a tip end of the horizontal bar portion. The guide path 141c-3 is a strip member that guides the terminal chain body TR11 pulled out from the terminal reel TR1 held by the reel holding portion 141a from the terminal reel TR1 to the crimping portion 141b. An end portion in the guide path 141c-3 from the frame body 141c-1 to the reel holding portion 141a has a curved shape corresponding to the L-shape of the pivot arm 141c-2 connecting the frame body 141c-1 and the reel holding portion 141a.

In the B-side terminal supply unit 14 (the same applies to the A-side terminal supply unit 15), the supply mechanism 142 holds the plurality of terminal reel units 141 as described above, and moves one terminal reel unit corresponding to the designation to a position where the terminal TR11a can be supplied to a crimping position.

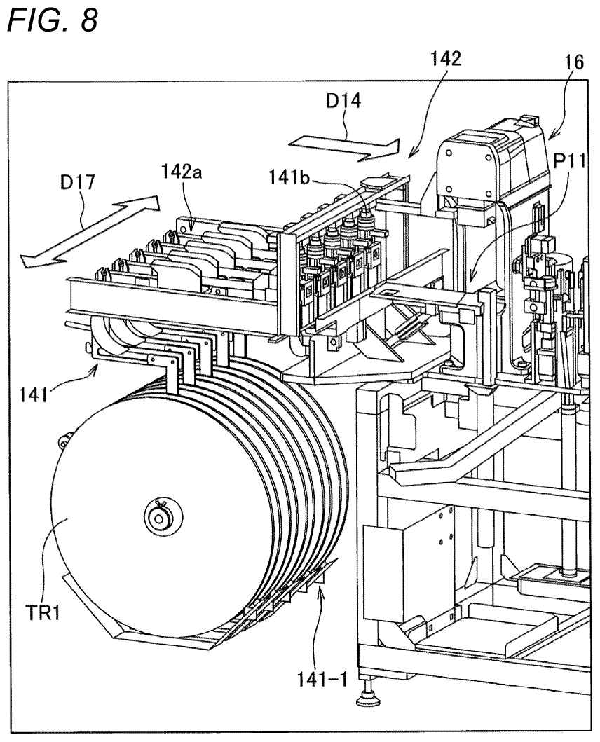

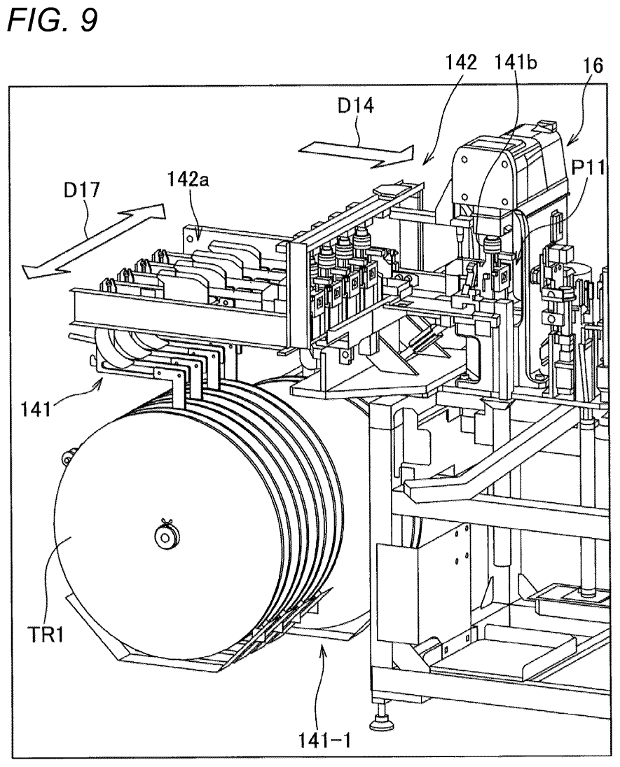

FIG. 8 is a view showing the plurality of terminal reel units and the supply mechanism in a state before the one terminal reel units is moved. Further, FIG. 9 is a view showing the plurality of terminal reel units and the supply mechanism in a state where the one terminal reel unit is moved.

First, the supply mechanism 142 is provided with the plurality of receiving slots 142a such that the plurality of terminal reel units 141 are set in a state of being arranged adjacently in an arrangement direction D17 intersecting the pull-out direction D14 of the terminal chain body TR11. Further, the terminal reel unit 141 is set in the respective one receiving slot 142a such that the crimping portion 141b is located away from a crimping machine setting position P11 in the pull-out direction D14. The crimping machine setting position P11 is a position in the body mechanism 16 where the crimping portion 141b is assembled into the B-side crimping machine 164 to perform the terminal crimping. In addition, when the crimping portion 141b is set at the crimping machine setting position P11, the crimping portion 141b is connected to various driving sources, and the B-side crimping machine 164 (the same applies to the A-side crimping machine 161) shown in FIG. 2 is constructed.In the state before the movement shown in FIG. 8, the crimping portion 141b is away from the crimping machine setting position P11 in the pull-out direction D14. In the present embodiment, the crimping portion 141b constituting a part of the B-side crimping machine 164 is described as an example of the crimping portion of the terminal reel unit. However, the crimping portion of the terminal reel unit is not limited thereto. The crimping portion may include an entire configuration of the crimping machine including various driving sources as long as the crimping portion constitutes at least a part of the crimping machine that performs the terminal crimping in the body mechanism. The same also applies to the A side.

When the target terminal reel is selected from among the plurality of types of terminal reels TR1 based on the part number data acquired by the information acquisition unit 11, the supply mechanism 142 moves one terminal reel unit 141-1 holding the target terminal reel among the plurality of terminal reel units 141. In the examples of FIGS. 8 and 9, a deepest side in a depth direction in the drawing is the one terminal reel unit 141-1 to be moved. When the one terminal reel unit 141-1 is determined based on the part number data, the supply mechanism 142 performs the following two-stage moving operation.

First, the supply mechanism 142 slides the plurality of terminal reel units 141 in the arrangement direction D17 until the crimping portion 141b for the determined one terminal reel unit 141-1 is aligned with the crimping machine setting position P11 in the pull-out direction D14. This sliding movement is performed by sliding the plurality of receiving slots 142a receiving the plurality of terminal reel units 141 in the arrangement direction D17. Next, the supply mechanism 142 pushes the one terminal reel unit 141-1 in the pull-out direction D14 until the crimping portion 141b reaches the crimping machine setting position P11. Due to the pushing, the crimping portion 141b is set at the crimping machine setting position P11, and the B-side crimping machine 164 is constructed.

In the electric wire processing apparatus 1 of the present embodiment, the terminal TR11a and the electric wire W1 are supplied to the crimping portion 141b of the B-side crimping machine 164 constructed as described above, and the terminal crimping is performed. In addition, the same operation is performed on the A side, and the terminal-equipped electric wire W11 as shown in FIG. 3 is manufactured.

Here, in the present embodiment, as described above, in each terminal reel unit 141, the reel holding portion 141a that holds the terminal reel TR1 is pivotally supported via the pivot arm 141c-2. The reel holding portion 141a is pivoted during replacement of the terminal reel TR1 or the like as to be described below.

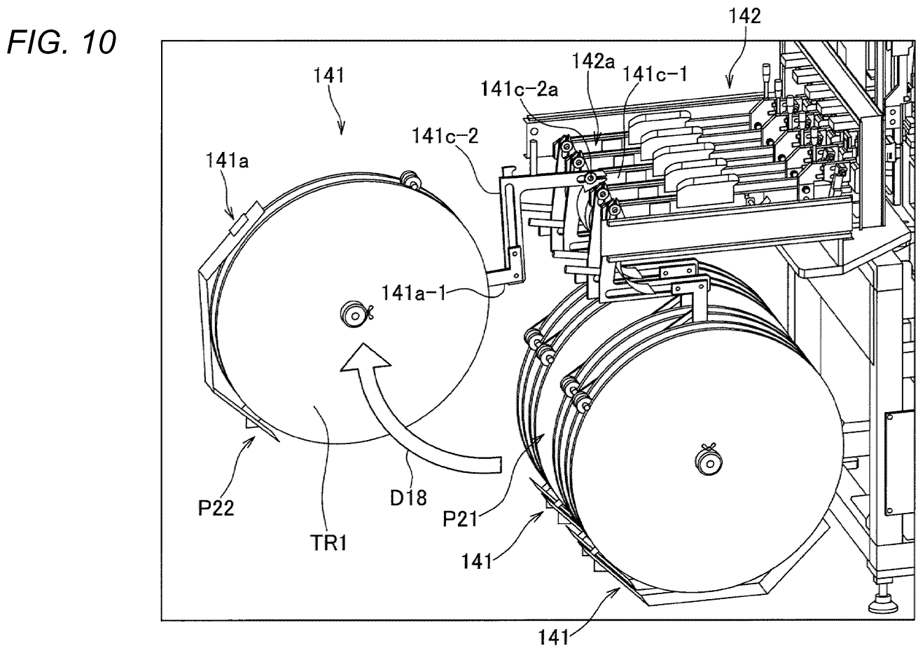

FIG. 10 is a view showing a state where the reel holding portion of the terminal reel unit that is the replacement target is pivoted during replacement of the terminal reel or the like.

In the example of FIG. 10, the terminal reel unit 141 located at a center of the arrangement among the plurality of terminal reel units 141 is the replacement target in which the terminal reel TR1 is to be replaced. At this time, in a state where the plurality of terminal reel units 141 are arranged adjacently, other terminal reel units 141 other than the replacement target is an obstacle, and it is difficult to access the terminal reel TR1 of the central terminal reel unit 141. Meanwhile, in the present embodiment, the skeleton frame 141a-1 of the reel holding portion 141a is pivotally supported by the frame body 141c-1 via the pivot arm 141c-2. With such a pivotal support structure, as shown in FIG. 10, the reel holding portion 141a of the terminal reel unit 141 that is the replacement target can be pivoted in the pivoting direction D18 around the rotation shaft 141c-2a. By the pivoting, the reel holding portion 141a can be moved to a position where the terminal reel TR1 can be attached and detached. The pivot arm 141c-2 of each terminal reel unit 141 is a member that supports the reel holding portion 141a pivotally between a first position P21 and a second position P22 as to be described below. The first position P21 is a position where the terminal chain body TR11 can be pulled out from the terminal reel TR1 to the crimping portion 141b. Further, the second position P22 is a position where the terminal reel TR1 can be attached to and detached from the reel holding portion 141a. Further, in the present embodiment, the first position P21 and the second position P22 are set to be separated from each other to positions at which it is easy to perform work around the rotation shaft 141c-2a (pivoting center).

Unlike the present embodiment, in replacement work of the terminal reel TR1 in a case where such a pivotal support structure is not provided, when the replacement target is at the center of the arrangement or the like, a treatment such as pulling out the terminal reel unit 141 that is the replacement target from the receiving slot 142a of the supply mechanism 142 is taken. On the other hand, in the present embodiment, by the reel holding portion 141a pivoting to the second position P22, the replacement of the terminal reel TR1 can be performed without being obstructed by other members.

According to the terminal reel unit 141 and the electric wire processing apparatus 1 of the embodiment described above, the crimping portion 141b is provided in the terminal reel unit 141 together with the reel holding portion 141a that holds the terminal reel TR1. With such a configuration, in the electric wire processing apparatus 1, the crimping portion 141b can be set simultaneously with the movement of the terminal reel unit 141. Therefore, the number of processes in preceding stages of the terminal crimping can be reduced and the processes in the preceding stages can be efficiently performed.

Here, in the present embodiment, the reel holding portion 141a of the terminal reel unit 141 is supported pivotally via the pivot arm 141c-2 between the first position P21 where the terminal chain body TR11 can be pulled out and the second position P22 where the terminal reel TR1 can be attached and detached. According to the configuration, when one terminal reel TR1 is attached or detached for replacement, by the reel holding portion 141a pivoting to the second position P22, the terminal reel TR1 can be easily attached or detached without being hindered by other terminal reel units 141. Further, in the configuration, it is not necessary to move the terminal reel units 141 that are not the replacement target. Therefore, for example, when the terminal reel TR1 is to be replaced for another terminal reel unit 141 other than the terminal reel unit 141 in which the terminal supply operation is in progress, the terminal reel TR1 can be attached and detached without stopping the terminal supply operation in progress.

Further, in the present embodiment, the first position P21 and the second position P22 are separated from each other around a pivot center to positions at which it is easy to perform work. According to the configuration, when the reel holding portion 141a is pivoted to a position where the reel holding portion 141a can be easily operated to the second position P22, the reel holding portion 141a is positioned at a position where the reel holding portion 141a is maximally separated from other terminal reel units 141 and is easy to be handled, and thus the terminal reel TR1 can be more easily attached and detached.

Further, in the present embodiment, the unit frame 141c is provided with the guide path 141c-3 for guiding the terminal chain body TR11. According to the configuration, the terminal chain body TR11 can be stably fed from the terminal reel TR1 to the crimping portion 141b by the guide path 141c-3.

Further, in the present embodiment, in the electric wire processing apparatus 1, the supply mechanism 142 for the terminal reel TR1 moves the one terminal reel unit 141-1 corresponding to the part number data among the plurality of terminal reel units 141 in the following two stages. The supply mechanism 142 first slides the plurality of terminal reel units 141 together in the arrangement direction D17, and then pushes the one terminal reel unit 141-1 corresponding to the designation in the pull-out direction D14 of the terminal chain body TR11. According to the configuration, the electric wire processing apparatus 1 can be smoothly shifted to a state in which the terminal crimping can be performed by the sliding movement of the plurality of terminal reel units 141 in the supply mechanism 142 and the subsequent push-out of the one terminal reel unit 141-1.

The embodiment described above merely shows a representative form of the terminal reel unit and the electric wire processing apparatus, and the terminal reel unit and the electric wire processing apparatus are not limited to the embodiment. That is, the terminal reel unit and the electric wire processing apparatus can be variously modified and implemented without departing from the gist thereof.

For example, in the above-described embodiment, as an example of the electric wire processing apparatus, the electric wire processing apparatus 1 in which the target terminal reel is selected based on the part number data is described. However, the electric wire processing apparatus is not limited thereto, and for example, the target terminal reel may be directly selected, and a specific selection mode is not limited.

Further, in the above-described embodiment, as an example of the electric wire processing apparatus, the electric wire processing apparatus 1 in which the terminal reel unit 141 with the crimping portion 141b is mounted on both the A-side terminal supply unit 15 and the B-side terminal supply unit 14 is described. However, the electric wire processing apparatus is not limited thereto, and may be an apparatus in which the terminal reel unit with the crimping machine is mounted on only one of the two terminal supply units on the A side and the B side.

Further, in the above-described embodiment, the terminal reel unit 141 in which the reel holding portion 141a is pivotally supported is described as an example of the terminal reel unit. However, the terminal reel unit is not limited thereto, and may not include such a pivoting structure, and may be a unit in which the reel holding portion is fixedly supported, or the like. A point in which, by pivotally supporting the reel holding portion 141a, the terminal reel TR1 can be easily attached and detached and the terminal reel TR1 can be attached and detached without stopping the terminal supply operation in progress is as described above.

Further, in the above-described embodiment, as an example of the terminal reel unit, the terminal reel unit 141 in which the reel holding portion 141a is positioned at the first position P21 and the second position P22 which are separated to positions at which it is easy to perform work is described. However, the terminal reel unit is not limited thereto, and a pivoting range of the reel holding portion 141a can be set freely. A point in which the terminal reel TR1 can be attached and detached more easily by setting the pivoting range between positions where it is easy to perform the work is as described above.

Further, in the above-described embodiment, as an example of the terminal reel unit, the terminal reel unit 141 in which the unit frame 141c is provided with the guide path 141c-3 is described. However, the terminal reel unit is not limited thereto, and the guide path may not be provided. A point in which the terminal chain body TR11 can be stably fed to the crimping portion 141b by providing the guide path 141c-3 is as described above.

Further, in the above-described embodiment, as an example of the electric wire processing apparatus, the electric wire processing apparatus 1 that performs two-stage movement including the sliding movement of the plurality of terminal reel units 141 and the subsequent push-out of the one terminal reel unit 141-1 is described. However, the electric wire processing apparatus is not limited thereto, and a specific movement mode of the one terminal reel unit corresponding to designation is not limited thereto. A point in which the electric wire processing apparatus 1 can be smoothly shifted to a state in which the terminal crimping can be performed by adopting the above-described two-stage movement is as described above.

### REFERENCE SIGNS LIST

1: electric wire processing apparatus
1a: apparatus body
11: information acquisition unit
12: electric wire storage rack
13: electric wire supply device
14: B-side terminal supply unit
15: A-side terminal supply unit
16: body mechanism
16a: cutout part
16a-1: feed-out mechanism
16a-2: cutting mechanism
17a: A-side rubber plug supply unit
17b: B-side rubber plug supply unit
121: rack body
122: electric wire reel
141: terminal reel unit
141-1: one of the terminal reel units
141a: reel holding portion
141a-1: skeleton frame
141a-2: reel cover
141a-3: reel support shaft
141a-3a: holding member
141a-4: interlayer paper winding portion
141b: crimping portion
141b-1: crimper
141c: unit frame
141c-1: frame body
141c-2: pivot arm
141c-2a: rotation shaft
141c-3: guide path
142: supply mechanism
142a: receiving slot
161: A-side crimping machine
162: A-side rubber plug inserting machine
163: A-side electric wire moving arm
164: B-side crimping machine
165: B-side rubber plug inserting machine
166: B-side electric wire moving arm
D11: feed-out direction
D12, D13: arrow
D14: pull-out direction
D15: electric wire supply direction
D17: arrangement direction
D18: pivoting direction
P11: crimping machine setting position
P21: first position
P22: second position
T11: A-side terminal
T12: B-side terminal
TR1: terminal reel
TR11: terminal chain body
TR11a: terminal
TR11b: carrier
W1: electric wire
W11: terminal-equipped electric wire
W111: segment electric wire
Y: operator

What is claimed is:

1. A terminal reel unit comprising:
a reel holding portion configured to detachably hold a terminal reel around which a strip-shaped terminal chain body in which a plurality of terminals is connected to each other is wound;
a crimping portion which is disposed at a position in a front side with respect to the terminal reel in a pull-out direction of the terminal chain body from the terminal reel when the terminal reel is held by the reel holding portion, the crimping portion forming at least a part of a crimping machine configured to crimp the terminal of the terminal chain body having been pulled out from the terminal reel, to an electric wire and to separate the terminal from the terminal chain body; and
a unit frame being a frame set detachably with respect to a device configured to supply the terminal to the crimping machine, and to which the reel holding portion and the crimping portion are attached.

2. The terminal reel unit according to claim 1, wherein
the unit frame includes:
a frame body formed in an elongated shape and attached to the crimping portion at one end thereof, and
a pivot arm attached to another end of the frame body on an opposite side with respect to the crimping portion, and configured to support the reel holding portion in a rotatable manner between a first position where pull-out of the terminal chain body from the terminal reel to the crimping portion is allowed and a second position where attachment and detachment of the terminal reel are allowed, about a rotation shaft intersecting with the another end of the frame body.

3. The terminal reel unit according to claim 1, wherein
the unit frame is provided with a guide path configured to guide the terminal chain body having been pulled out from the terminal reel, from the terminal reel held by the reel holding portion to the crimping portion.

4. An electric wire processing apparatus comprising:
a plurality of the terminal reel units according to claim 1;
a supply mechanism in which the plurality of terminal reel units is detachably set, the plurality of terminal reel units having respective one of the terminal reels of different types, each of the terminal reels having a terminal type different from others, the supply mechanism being configured to move, when a target terminal reel is selected out of the plurality of types of terminal reels, one terminal reel unit holding the target terminal reel among the plurality of terminal reel units to a crimping machine setting position where the crimping portion is set in the crimping machine; and
an apparatus body configured to cut out a segment electric wire or to manufacture a terminal-equipped electric wire by crimping the terminal in the terminal chain body pulled out from the target terminal reel held by the one terminal reel unit, to at least one end of the segment electric wire using the crimping machine.

5. The electric wire processing apparatus according to claim 4, wherein
in a state where the plurality of terminal reel units is arranged adjacently along an arrangement direction intersecting the pull-out direction of the terminal chain body, the crimping portion is set at a position away from the crimping machine setting position in the pull-out direction, and when the target terminal reel is selected, the supply mechanism first slides the plurality of terminal reel units in the arrangement direction until the crimping portion for the one terminal reel unit is aligned with the crimping machine setting position in the pull-out direction, and then pushes the one terminal reel unit in the pull-out direction until the crimping portion reaches the crimping machine setting position.
